(19) United States
(12) Patent Application Publication
(10) Pub. No.: US 2026/0307423 A1
(43) Pub. Date: Oct. 8, 2026

(54) ENCODED INKJET COLORSHIFT

(71) Applicant: THALES DIS FRANCE SAS, Meudon (FR)

(72) Inventors: Teemu POHJOLA, Espoo (FI); Mikko LANKINEN, Helsinki (FI); Laurent DAVOINE, Rosenau (FR); Jukka MÖKSY, Vantaa (FI); Manu NURMINEN, Helsinki (FI); Anna MAJEWSKA, Pruszcz Gdanski (FI)

(73) Assignee: THALES DIS FRANCE SAS, Meudon (FR)

(21) Appl. No.: 19/482,275

(22) PCT Filed: Jul. 11, 2024
(86) PCT No.: PCT/EP2024/069744

§ 371 Date: Nov. 7, 2025

(30) Foreign Application Priority Data
May 11, 2023 (EP) 23315191.9

(51) Int. Cl. B42D 25/324; B42D 25/24; B42D 25/305; B42D 25/309

(52) U.S. Cl. CPC B42D 25/324; B42D 25/24; B42D 25/305; B42D 25/309

(57) ABSTRACT

Provided is a data carrier for a secure article such as a passport comprises a carrier body and at least one security element on the carrier body. The security element comprises at least one image printed on at least one surface structure extending along an extension direction (E). The image comprises at least one primary image and at least one secondary image encoded in the primary image The surface structure is configured to decode the secondary image when the data carrier is viewed under different viewing angles and/or illuminated under different illumination angles, whereby the secondary image becomes observable.

### TECHNICAL FIELD

The present invention relates to a data carrier for a secure article according to claim 1, a secure article comprising or consisting of such a data carrier according to claim 13, and to a method of producing a data carrier for a secure article according to claim 14.

### PRIOR ART

Data carriers for secure articles such as passports generally comprise personalization elements such as an image of the document holder or other holder data such as a name, date of birth, etc. These personalization elements are often provided as a print such as an inkjet print on a surface of the data carrier. In such a case, the personalization element may easily be tampered by removing and replacing it by fraudulent data or by partially altering it.

### SUMMARY OF THE INVENTION

It is an object of the present invention to provide a data carrier for a secure article of increased security against forgery.

This object is achieved with a data carrier according to claim 1. In particular, a data carrier for a secure article such as a passport is provided. The data carrier comprises a carrier body and at least one security element being provided on the carrier body. The security element comprises at least one image being printed on at least one surface structure extending along an extension direction. The image comprises at least one primary image and at least one secondary image being encoded in the primary image. The surface structure is configured to decode the secondary image when the data carrier is viewed under different viewing angles and/or illuminated under different illumination angles, whereby the secondary image becomes observable.

That is, the security element is formed by an image being printed on the surface structure. To this end it is particularly preferred that the print is an inkjet print being printed onto the surface structure with an inkjet printer.

Said image, which can be seen as an output image, comprises at least a primary image and a secondary image, wherein the secondary image is encoded or embedded into the primary image. Hence, the primary image can be seen as a source image or background image, into which the secondary image is hidden. Said secondary image is revealed and becomes observable in the event that the data carrier is viewed under a particular viewing angle and/or illuminated under a particular illumination angle. In particular, in order to decode the secondary image, i.e. to reveal or make the secondary image observable for an observer of the data carrier, the data carrier needs to be observed and/or illuminated under appropriate viewing angles and/or illumination angles such that the surface structure reveals the secondary image to the observer. That is, the surface structure serves the purpose of a decoder that decodes i.e. reveals or renders observable, the secondary image. Hence, the data carrier preferably offers several possibilities of decoding the secondary image, namely i) upon tilting the data carrier and due to the viewing angle, ii) based on lighting of the data carrier and due to the illumination angle, wherein the surface structure can be seen as shadowing light coming in from a particular angle such as close to a surface of the data carrier, and iii) based on a combination of i) and ii) that can be seen as a combination of the illumination angle and the viewing angle.

For instance, and as will be explained in greater detail below, the secondary image can be a text or picture that a human observer can recognize and that only becomes observable due to the combination of the surface structure and the illumination angle and/or the viewing angle. This “observation” is understood as “decoding” the secondary image by the surface structure.

A spatial extent of the secondary image is preferably smaller than a spatial extent of the primary image. That is, it is preferred that a size of the secondary image is smaller than a size of the primary image.

The primary image is preferably observable when the data carrier is viewed under at least a first viewing angle and a second viewing angle and/or when the data carrier is illuminated under at least a first illumination angle and a second illumination angle. Furthermore, the secondary image is preferably hidden when the data carrier is viewed under the first viewing angle and/or when the data carrier is illuminated under the first illumination angle but observable when the data carrier is viewed under the second viewing angle and/or when the data carrier is illuminated under the second illumination angle.

That is, whereas the primary image is preferably observable when the data carrier is viewed under the first and second viewing angles, the secondary image is preferably observable only under one of the viewing angles but remains hidden or non-observable under the other viewing angle.

Additionally or alternatively, whereas the primary image is preferably observable when the data carrier is illuminated under the first and second illumination angles, the secondary image is preferably observable only when the data carrier is illuminated under one of the illumination angles but remains hidden or non-observable when the data carrier is illuminated under the other illumination angle.

A first viewing angle could be the normal view of the data carrier and the second viewing angle could be an oblique viewing of the data carrier along a direction inclined to a surface of the data carrier.

It should be noted here that the primary image and/or the secondary image can be observable for further viewing angles and/or illumination angles. For instance, the primary image could be observable when the data carrier is viewed under a third viewing angle and/or when being illuminated under a third illumination angle. Additionally or alternatively, the secondary image could be observable when the data carrier is viewed under the third viewing angle and/or when being illuminated under the third illumination angle. In fact, the secondary image is preferably configured such that there is at least one viewing angle and/or illumination angle under which it is hidden.

The security element, in particular the primary image and/or the secondary image, is preferably configured to exhibit different appearances when the data carrier is viewed under different viewing angles and/or illumination angles. The different appearances are preferably a different luminescence and/or a different colour and/or a different intensity and/or a different brightness and/or a different reflectance.

In particular, an appearance of the primary image preferably differs when the data carrier is viewed under different viewing angles and/or when the data carrier is illuminated under different illumination angles.

Additionally or alternatively, an appearance of the secondary image preferably differs when the data carrier is viewed under different viewing angles and/or when the data carrier is illuminated under different illumination angles.

For instance, the primary image preferably has a first appearance when being viewed under the first viewing angle (illuminated under the first illumination angle) and a second appearance when being viewed under the second viewing angle (illuminated under the second illumination angle). The secondary image preferably exhibits such different appearances in dependence of the viewing angle and/or illumination angle as well, however while remaining hidden under at least one viewing angle and/or illumination angle.

The primary image and the secondary image are preferably observable to an un-aided eye.

The primary image and the secondary image being observable to the un-aided eye means that no additional decoders than the surface structure are required for observing them. Furthermore, the primary image and/or the secondary image can be configured such that no viewing adds such as a microscope or the like is necessary for observing them. That is, the primary image and the secondary image are preferably observable by the bare eye.

The security element is preferably self-verifying. That is, a verification of the authenticity of the security element can be performed by means of the security element itself, wherein the observer merely needs to tilt the data carrier and observe the data carrier under different viewing angles and/or to illuminate the data carrier under different illumination angles. No additional elements such as lenses or the like are required.

At least part of the primary image and/or at least part of the secondary image can be of a single-colour or of a multi-colour.

Additionally or alternatively, at least part of the primary image is non-coloured and/or white and/or grey. Being non-coloured is preferably understood as being white and/or grey as distinguished from being coloured such as being red, blue, yellow, etc.

Additionally or alternatively, at least part of the secondary image is preferably transparent and/or comprises or consists of at least one varnish. It is preferred that the varnish is a transparent varnish.

To this end, it is particularly preferred that a secondary image or parts thereof being transparent and/or a varnish such as a transparent varnish is encoded in a primary image or parts thereof that is non-coloured and/or white and/or grey.

However, it is likewise conceivable that a secondary image or parts thereof being transparent and/or a varnish such as a transparent varnish is encoded in a primary image or parts thereof that is coloured.

At least part of the primary image preferably comprises primary colour pixels and at least part of the secondary image preferably comprises secondary colour pixels. These primary colour pixels are preferably present in the event of the primary image or parts thereof being coloured as well as when being non-coloured and/or white and/or grey. For instance, the primary image can comprise primary colour pixels being white or grey. Likewise, these secondary colour pixels are preferably present in the event of the secondary image or parts thereof being coloured as well as when being transparent and/or a varnish. For instance, the secondary image can comprise secondary colour pixels being transparent.

A luminance and/or an intensity and/or a brightness and/or colour and/or a reflectance of at least some primary colour pixels is preferably changed with respect to a luminance and/or an intensity and/or a brightness and/or a colour and/or a reflectance of neighbouring secondary colour pixels such that a difference in appearance between the primary colour pixels and the secondary colour pixels is generated when the data carrier is observed under different viewing angles, for instance at oblique view.

To this end it is particularly preferred that the primary image is modulated according to at least one modulation pattern and the secondary image is modulated according to said at least one modulation pattern but shifted, preferably by a half-period of the modulation pattern, whereby a difference in appearance between the primary colour pixels and the secondary colour pixels is created when the data carrier is viewed under different viewing angles while an average appearance of the security element remains unchanged.

In particular, the primary image and the secondary image are preferably provided by corresponding colour pixels, and wherein a size of the colour pixels is preferably such that the individual colour pixels are not distinguished from one another by an observer when the data carrier is observed at the typical observation distances at which data carriers for instance of passports are typically observed. Instead, only an average appearance of the neighboring colour pixels is perceived. Thus e.g. two colour pixels of a same color may be changed such that one is made e.g. lighter and the other one an equal amount darker to maintain their average lightness and thus the appearance remains the same but the difference between the two colour pixels may become visible because of the interplay between the surface structure and the viewing angle and/or the illumination angle, for example. Similarly, with this same two-pixel example one of the colour pixels could be made a bit more reddish and the other one less reddish, wherein the overall appearance is red and the individual appearance of one of the colour pixels is more reddish and the individual appearance of the other colour pixel is less reddish, etc.

However, it should be noted that in the event of a transparent secondary image (or parts thereof) being embedded in at least parts of a primary image, said parts of the primary image does not necessarily have to appear disturbed by the transparent parts of the secondary image. Instead, it is conceivable that the transparent secondary image or parts thereof is arranged such as printed on top of the primary image, and wherein only the transparent secondary image or the parts thereof exhibits a different appearance when the data carrier is viewed under different viewing angles and/or illuminated under different illumination angles.

At this point it is noted that the security element can comprise coloured primary and secondary images. Likewise, it is conceivable that the security element comprises a non-coloured and/or white and/or grey primary image and a transparent secondary image and/or a secondary image in the form of a varnish. Likewise, it is conceivable that the security element comprises both i) a primary image comprising at least a first primary image part being coloured and a second primary image part being non-coloured and/or white and/or grey and ii) a secondary image comprising at least a first secondary image part being coloured and a second secondary image part being transparent and/or a varnish. In this latter case it is preferred that the second primary image parts constitutes a background such as a white background of the first primary image part such as a portrait or the like.

The surface structure preferably comprises elevations extending away from the carrier body and/or depressions extending towards the carrier body. At least in regions, a distance between and/or a surface area of and/or a slope of the elevations and/or of the depressions preferably remains constant or changes with respect to the extension direction.

To this end it is particularly preferred that the surface structure comprises ridges, wherein said ridges are formed by alternatingly arranged depressions and elevations. In other words, a single ridge is formed by an elevation followed by a depression, wherein the elevation can be seen as the left side of the ridge and the depression can be seen as the right side of the ridge (or vice versa).

However, other surface structures such as a binary pattern are likewise conceivable. For instance, a binary pattern could be provided by depressions or elevations that extend as alternating horizontal and vertical lines or figuratively speaking, “the top of a castle wall” are likewise conceivable.

The surface structure is preferably associated with a surface pitch. The surface pitch is preferably configured for decoding the secondary image being encoded in the primary image.

At least in regions, a primary pitch being associated with the primary image preferably matches or mismatches the surface pitch.

At least in regions, a secondary pitch being associated with the secondary image preferably matches or mismatches the surface pitch.

To this end it is therefore preferred that a primary pattern is present in the primary image, and wherein said primary pattern defines the primary pitch.

Likewise, it is preferred that a secondary pattern is present in the secondary image, and wherein said secondary pattern defines the secondary pitch.

The surface pitch of the surface structure can be defined as a distance between successive elevations of the surface structure with respect to the extension direction or as a distance between two successive depressions with respect to extension direction, respectively. In the event of the surface structure being ridges, the surface pitch can be seen as the distance between successive ridges with respect to the extension direction, for instance a peak-to-Peak distance between the ridges.

If there is a mismatch in the pitches of the surface structure and the primary-image-elements and/or the secondary-image-elements, optical effects such as a Moiré-effect can be generated.

It is however likewise conceivable that the security element is configured to exhibit optical effects in the event of matching pitches such as flip effects.

Hence, the security element can be configured to exhibit different appearances based on optical effects when being observed under different viewing angles and/or when being illuminated under different illumination angles.

The primary image and/or the secondary image preferably are a picture and/or an alphanumeric character such as a name, date of birth, country of residence, coat of arms or the like.

The primary image and/or the secondary image are preferably machine readable.

The data carrier can further comprise at least one marking material being configured to interact with impinging laser radiation, and wherein the surface structure corresponds to a laser marking being generated in the marking material. That is, the surface structure can be generated by irradiating laser radiation onto the data carrier, in particular onto the marking material. However, it is likewise conceivable that the surface structure corresponds to an embossing. It is furthermore conceivable that the surface structure corresponds to a print, preferably an inkjet print.

The carrier body and/or the surface structure can comprise or consists of one or more paper-based compounds and/or one or more cardboard-based compounds and/or one or more plastics and/or one or more polymers.

The polymers preferably are thermoplastics and/or amorphous polymers, particularly preferably polycarbonate and/or polycarbonate blends and/or polycarbonate co-extrudates.

The carrier body preferably comprises one or more layers of at least one of a paper-based compound, a cardboard-based compound, a plastics or a polymer. Two or more layers are preferably connected to one another by means commonly known in the state of the art. For instance, if the carrier body comprises two or more layers comprising or consisting of polymers and/or plastics, these layers could be connected to one another via lamination. In this case, the carrier body preferably corresponds to a so-called card body as it is commonly known in the card industry. However, other types of layers and/or connection means are likewise conceivable. For instance, layers of a paper-based compound could be glued to one another.

In the event that the data carrier comprises the marking material, it is preferred to provide the marking material after the carrier body is generated on a surface of the carrier body, in particular on a top surface of the carrier body. To this end it is preferred that the marking material is provided as one or more layers as well. The marking material particularly preferably corresponds to polycarbonate or another plastic that preferably comprises laser sensitive additives. Once that the marking material is provided on the carrier body, it is preferred to generate the surface structure in the marking material by irradiating laser radiation onto the marking material. In regions of impingement of the laser radiation, the marking material is preferably colour-changed around the laser sensitive additives, and wherein a strong reaction can result in a foam like structure that extends up from a surface of the data carrier. Such marking is typically black and is generally known as tactile laser marking. With some lasers and/or laser settings it is possible to achieve also whitish tactile marking.

However, it is likewise conceivable that no such marking material is present. In this case, it is preferred that the surface structure is produced in the carrier body itself, preferably by embossing a structure into the carrier body, particularly preferably into the top surface of the carrier body. For instance, said structure could be provided on a lamination plate that is used to laminate the layers of the card body, wherein the structure is embossed into the carrier body and the surface structure in the form of an embossing is generated. As such, it is preferred that the surface structure is an integral component, i.e. formed into, the top surface of the carrier body.

In the event of the surface structure being a print such as an inkjet print said print is preferably printed on a surface of the carrier body as just mentioned.

The surface structure being a print preferably corresponds to a three-dimensional profile being printed. Said surface structure particularly preferably is inkjet printed according to known inkjet techniques. That is, the surface structure can be generated in different ways such as by intaglio printing or lamination, tactile laser marking or printing.

In the event of a plastic product it is preferred that a plastic surface is embossed for instance by heat and that pressure using a structured lamination plate surface against the substrate surface is applied. In the event of a paper product, it is preferred to use a specific printing process that similarly uses structured plates and high pressure (not heat), which is also known as Intaglio printing. However, it is likewise conceivable to use plates only and no ink, wherein an embossing in the paper surface being similar to the lamination of the plastic surface is achieved.

The data carrier preferably defines a top side, and wherein the security element is provided on the top side the data carrier.

The security element is particularly preferably provided on a top surface, i.e. the outermost surface, of the data carrier. As such, it is preferred that the security element is arranged on the data carrier so as to face towards an outside of the data carrier.

Said top surface of the data carrier preferably corresponds to the top surface of the carrier body or to the marking material. Consequently, in the former case, it is preferred that the surface structure is an integral component of the top surface of the data carrier. In the latter case, it is preferred that the marking component and thus the surface structure is arranged on the top surface of the data carrier.

In another aspect a secure article comprising or consisting of at least one data carrier as described above is provided. The secure article preferably is an identity card, a passport, a credit card, a smart card, a driving license, a data page or the like.

It should be understood that the data carrier per se can correspond to a secure article. This is the case if the data carrier is provided in the form of an identity card, for example. However, it is likewise conceivable to introduce or incorporate the data carrier into a secure article. In the case of a passport for example the data carrier could correspond to or could be incorporated in a page of the passport.

Any explanations provided with regard to the data carrier per se preferably likewise apply to the secure article and vice versa.

In another aspect a method of producing a data carrier for a secure article such as a passport is provided, wherein the data carrier preferably is the data carrier as described above. The method comprises the steps of i) providing a carrier body, and ii) providing at least one security element being provided on the carrier body. The security element comprises at least one image being printed on at least one surface structure extending along an extension direction. The image comprises at least one primary image and at least one secondary image being encoded in the primary image. The surface structure is configured to decode the secondary image when the data carrier is viewed under different viewing angles and/or illuminated under different illumination angles, whereby the secondary image becomes observable.

Any explanations made with regard to the data carrier and the secure article preferably likewise apply to the method and vice versa.

The security element is preferably provided by the steps of:
Providing an original image;
Selecting at least a first area of the original image to be assigned to the primary image and selecting at least a secondary area of the original image to be assigned to the secondary image, wherein the secondary area is preferably arranged inside the primary area;
Modulating the primary area according to at least one modulation pattern, whereby the primary image is formed;
Modulating the secondary area according to the at least one modulation pattern and shifting said modulated secondary area, whereby the secondary image is formed;
Recombining the primary image and the secondary image, whereby the image is formed; and
Printing said image onto the surface structure preferably with an inkjet printer.

The modulation pattern preferably corresponds to a screen such as a round screen, line screen elliptical screen or the like.

The primary area and the secondary area are preferably modulated by changing a luminance and/or an intensity and/or a brightness and/or a colour of the primary area and the secondary area. It is particularly preferred that the primary area and the secondary area are modulated by changing a luminance and/or an intensity and/or a brightness and/or a colour of colour pixels to be assigned to primary colour pixels of the primary image and of colour pixels to be assigned to secondary colour pixels of the secondary image.

The modulated secondary area is preferably shifted along at least one spatial direction and/or along the extension direction.

The modulated secondary area is preferably shifted in accordance with a surface pitch of the surface structure. In fact, the modulated secondary area is particularly preferably shifted by half of the surface pitch.

In other words, the primary image, in the region of the secondary image, is preferably distorted, reformed or modified according to the secondary image. Said distortion or modification is preferably achieved by shifting the modulated secondary area providing the secondary image with respect to the first area providing the primary image.

Again in other words, the modulation pattern that is used to modulate the secondary area is preferably shifted at a location of the secondary image.

For instance, the primary image can be formed by dark and bright lines, and wherein said dark lines and bright lines are alternatingly arranged along the surface structure and the extension direction. The secondary image can be formed by shifting the order of the dark and bright lines along the extension direction, whereby the secondary image is encoded into the primary image. In a sense, the shifted dark and bright lines of the secondary image can be seen as deviations in the dark and bright lines of the primary image with respect to the extension direction.

In this way the secondary image is made unobservable, i.e. hidden, with respect to the primary image unless the data carrier is observed under the particular viewing angle(s) and/or illuminated under the particular illumination angle(s).

The method preferably further comprises the step of providing at least one marking material being configured to interact with impinging laser radiation on the carrier body and generating the surface structure as a laser marking by irradiating laser radiation onto the marking material.

Likewise, the method preferably comprises the step of embossing preferably a structure on a lamination plate into a surface of the carrier body and generating the surface structure as embossing. The inkjet print and the embossing are preferably generated based on a same data set being input to an inkjet printer and a lamination device comprising the lamination plate.

Likewise, the method preferably comprises the step of printing, in particular inkjet printing, a surface structure onto the surface of the carrier body.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematic representation of the production of a data carrier comprising a security element comprising an image being printed on a surface structure according to the invention;

FIG. 2a shows a partial perspective view of a surface structure comprising a print of another security element according to the invention under a first viewing angle;

FIG. 2b shows a partial perspective view of the surface structure comprising the print according to FIG. 2a under a second viewing angle;

FIG. 2c shows a partial perspective view of the surface structure comprising the print according to FIG. 2a under a third viewing angle;

FIG. 3a shows the print of the security element according to FIG. 2a;

FIG. 3b shows a simulation of the appearance of the security element according to FIG. 2a under a first viewing angle;

FIG. 3c shows a simulation of the appearance of the security element according to FIG. 2a under a second viewing angle;

FIG. 3d shows a simulation of the appearance of the security element according to FIG. 2a under a third viewing angle;

FIG. 4a shows a partial perspective view of a surface structure comprising a print of another security element according to the invention under a first viewing angle;

FIG. 4b shows a simulation of the appearance of the security element of FIG. 4a under the first viewing angle;

FIG. 5a shows a partial perspective view of the surface structure comprising the print according to FIG. 4a under a second viewing angle;

FIG. 5b shows a simulation of the appearance of the security element of FIG. 5a under the second viewing angle;

FIG. 6a shows a partial perspective view of the surface structure comprising the print according to FIG. 4a under a third viewing angle;

FIG. 6b shows a simulation of the appearance of the security element of FIG. 6a under the third viewing angle;

FIG. 7a shows the print of the security element according to FIG. 4a;

FIG. 7b shows a simulation of the appearance of the security element according to FIG. 4a under the first viewing angle;

FIG. 7c shows a simulation of the appearance of the security element according to FIG. 4a under the second viewing angle;

FIG. 7d shows a simulation of the appearance of the security element according to FIG. 4a under the third viewing angle;

FIG. 8a shows a partial perspective view of a surface structure comprising a print of another security element according to the invention under a first viewing angle;

FIG. 8b shows a simulation of the appearance of the security element of FIG. 8a under the first viewing angle;

FIG. 9a shows a partial perspective view of the surface structure comprising the print according to FIG. 8a under a second viewing angle;

FIG. 9b shows a simulation of the appearance of the security element of FIG. 9a under the second viewing angle;

FIG. 10a shows a partial perspective view of the surface structure comprising the print according to FIG. 8a under a third viewing angle;

FIG. 10b shows a simulation of the appearance of the security element of FIG. 10a under the third viewing angle;

FIG. 11a shows the print of the security element according to FIG. 8a;

FIG. 11b shows a simulation of the appearance of the security element according to FIG. 8a under the first viewing angle;

FIG. 11c shows a simulation of the appearance of the security element according to FIG. 8a under the second viewing angle;

FIG. 11d shows a simulation of the appearance of the security element according to FIG. 8a under the third viewing angle;

FIG. 12 shows a simulation of the appearance of another security element comprising an image being printed on a surface structure according to the invention;

FIG. 13a shows a simulation of the appearance of another security element comprising an image being printed on a surface structure according to the invention under a first viewing angle;

FIG. 13b shows a simulation of the appearance of the security element according to FIG. 13a under a second viewing angle;

FIG. 14a shows a simulation of the appearance of another security element comprising an image being printed on a surface structure according to the invention under a first viewing angle;

FIG. 14b shows a simulation of the appearance of the security element according to FIG. 14a under a second viewing angle;

FIG. 15 shows a simulation of the appearance of another security element comprising an image being printed on a surface structure according to the invention.

### DESCRIPTION OF PREFERRED EMBODIMENTS

Various aspects of a data carrier 1 for a secure article according to the invention will now be discussed in greater detail with respect to the figures.

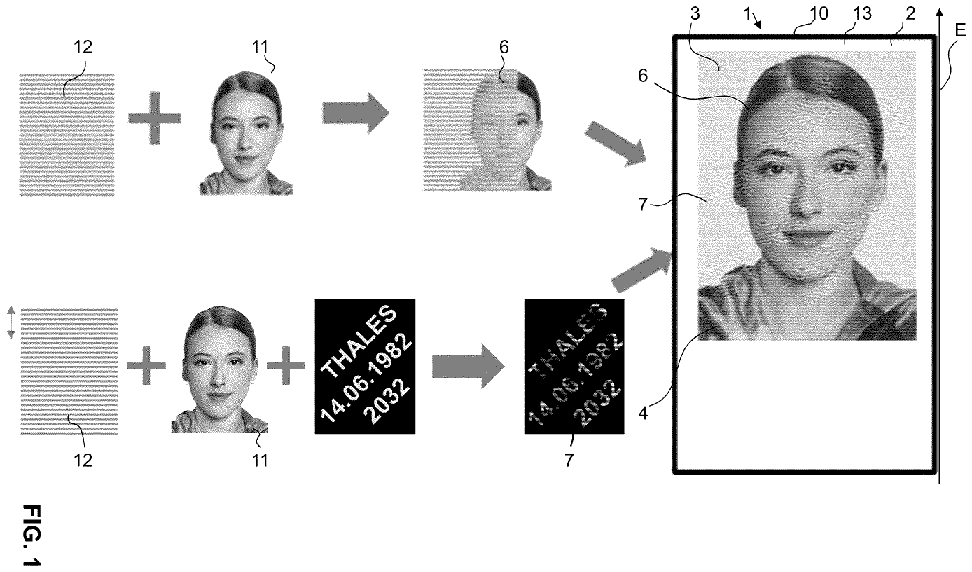

In particular, the data carrier 1 according to the invention comprises a carrier body 2 and at least one security element 3 being provided on the carrier body 2, in particular on a top side 10 of the data carrier 1 that corresponds here to a top surface 13 of the carrier body 2, see FIG. 1. The security element 3 comprises at least one image 4 being printed on at least one surface structure 5 extending along an extension direction E. The extension direction E runs parallel to the top side 10 of the data carrier 1, in particular parallel to a (fictitious) plane extending within the top surface 13 of the carrier body 2. The image 4 comprises at least one primary image 6 and at least one secondary image 7 being encoded in the primary image 6, wherein the surface structure 5 is configured to decode the secondary image 7 when the data carrier 1 is viewed under different viewing angles and/or illuminated under different illumination angles. In particular, in order to decode the secondary image 7, i.e. to reveal or make the secondary image 7 observable for an observer of the data carrier 1, the data carrier 1 needs to be observed and/or illuminated under appropriate viewing angles and/or illumination angles such that the surface structure 5 reveals the secondary image 7 to the observer. That is, the surface structure 5 serves the purpose of a decoder that decodes i.e. reveals or renders the secondary image observable.

As follows from FIG. 1, encoding can be generated by providing an original image 11 which is here in the form of a portrait. Then, at least a first area of the original image 11 to be assigned to the primary image 6 and at least a secondary area of the original image 11 to be assigned to the secondary image 7 are selected, wherein the secondary area is arranged inside the primary area. The primary area is modulated according to at least one modulation pattern 12, whereby the primary image 6 is formed. Likewise, the secondary area is modulated according to the modulation pattern 12, wherein said modulated secondary area is furthermore shifted along a spatial direction, which corresponds here to the extension direction E, whereby the secondary image 7 is formed. In the depicted example the modulation pattern 12 corresponds to a line screen of alternating dark and bright lines, and wherein the primary area and the secondary area are modulated by changing the luminance or colour of the primary area and the secondary area according to the given modulation pattern, here the line screen. Thereafter, the primary image 6 and the secondary image 7 are recombined so as to form the image 4, and said image 4 is then printed onto the surface structure 5 preferably with an inkjet printer. Hence, the encoding consists here of creating the primary image 6 and the secondary image 7 that are recombined at the end, and wherein the primary image 6 in the form of the portrait corresponds to the primary areas outside of the secondary image 7, and wherein the secondary image 7 is provided by the secondary areas in the form of the text being arranged inside the portrait or primary image, respectively.

As is illustrated in the further figures, the primary image 6 is observable when the data carrier 1 is viewed under different viewing angles, whereas the secondary image 7 is observable only under some of the viewing angles but remains hidden or non-observable under other viewing angles.

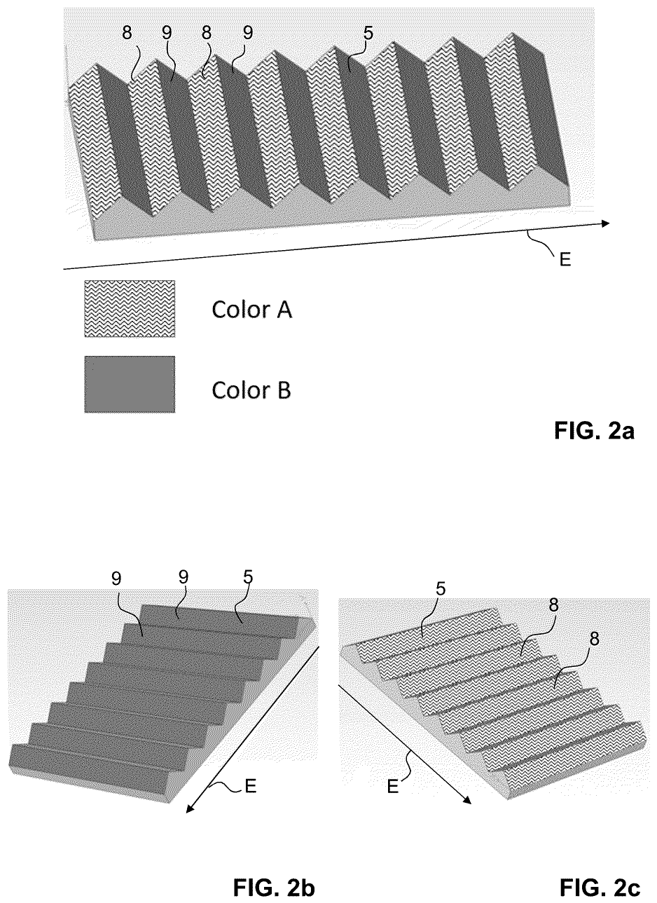

In particular, FIGS. 2a to 2c depict a surface structure 5 comprising an image 4 in the form of a print, wherein the surface structure 5 comprises elevations 8 extending away from the carrier body 2 and depressions 9 extending towards the carrier body 2. That is, the surface structure 5 has here the shape of ridges. In the depicted examples, the surface structure 5 is regular, i.e. a distance between the elevations 8 and depressions 9 as well as a surface area and slope of the elevations 8 and depressions 9 remains constant with respect to the extension direction E.

The surface structure 5 is associated with a surface pitch, and wherein the surface pitch is configured for decoding the secondary image 7 being encoded in the primary image 6. The surface pitch of the surface structure 5 is defined as the distance between successive elevations 8 of the surface structure 5 with respect to the extension direction E or as the distance between two successive depressions 9 with respect to extension direction E, respectively. When defining these elevations and depressions as ridges, the surface pitch an also be seen as the distance between successive ridges.

As furthermore follows from these figures, a primary pitch being associated with the primary image 6 matches the surface pitch. Moreover, a secondary pitch being associated with the secondary image 7 matches the surface pitch. The primary pitch corresponds here to a pitch of the modulation pattern being present inside the primary image, i.e. the primary image comprises a primary pattern that has here the form of a line pattern. In this case the primary pitch can be seen as the distance between successive lines with respect to the extension direction E. Likewise, the secondary pitch corresponds to a pitch of the modulation pattern being present inside the secondary image, i.e. the secondary image comprises a secondary pattern. In the depicted example the secondary pattern corresponds to a line pattern as well, and wherein the secondary pitch can be seen as the distance between two successive lines with respect to the extension direction E.

The security element 3, in particular the primary image 6 and the secondary image 7, is configured to exhibit different appearances when the data carrier 1 is viewed under different viewing angles and/or illumination angles. These different appearances can be a different luminescence, different colour, different intensity, different brightness, different reflectance or the like.

In particular, the primary image 6 comprises primary colour pixels and the secondary image 7 comprises secondary colour pixels. The primary image 6 is modulated according to a modulation pattern 12. Also the secondary image is modulated according to said modulation pattern 12, wherein said modulation pattern 12 is however shifted by for instance the half-period of the modulation pattern 12. As a consequence, a difference in appearance between the primary colour pixels and the secondary colour pixels is created when the data carrier 1 is viewed under different viewing angles, for instance at oblique view, while an average appearance of the security element 3 remains unchanged. In other words, the security element exhibits an average appearance because the original image 11 is modulated such that for example every second line get brighter while the other lines get darker. As a consequence, a local appearance of the security element in average is the same as the original picture.

These different appearances are now discussed in greater detail with respect to FIGS. 2a to 15.

Namely, FIGS. 2a to 2c show different views of a surface structure 5 seen under different viewing angles. Said surface structure 5 comprises an image 4 in the form of a print of two colours, colour A being arranged on the elevations 8 only and colour B being arranged on the depressions 9 only. That is, the print 4 comprises alternating light and dark grey lines that are alternatingly arranged along the extension direction E. Under a first viewing angle depicted in FIG. 2a the elevations 8 and depressions 9 of the surface structure 5 and consequently both colours A and B are visible. Under a second viewing angle depicted in FIG. 2 b, the surface structure 5 faces towards the observer such that only color B is visible. Under a third viewing angle depicted in FIG. 2c, the surface structure 5 faces towards the observer such that only color A is visible.

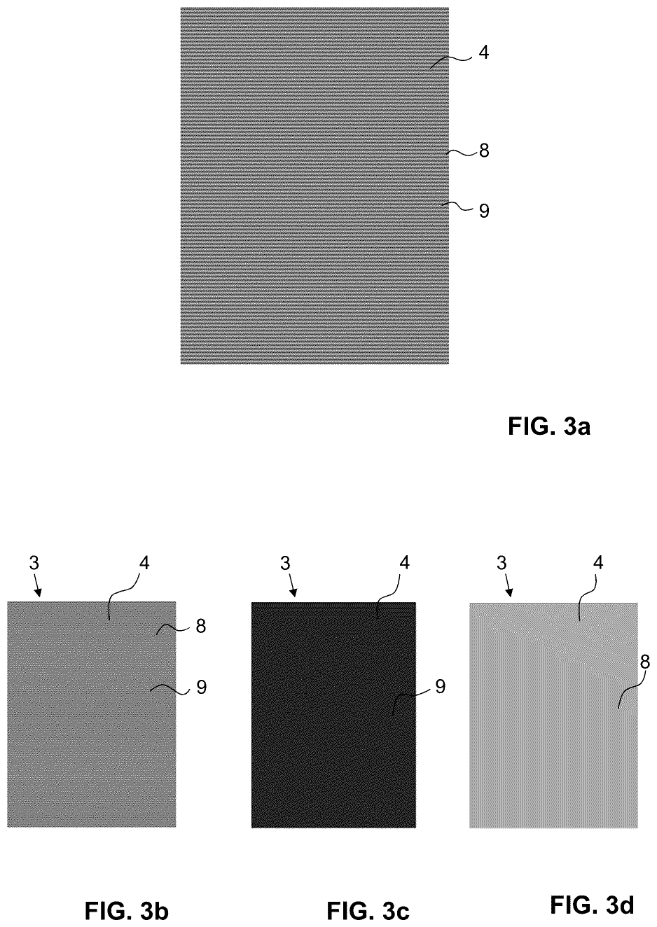

With respect to FIGS. 3a to 3b the appearances associated with such a security element 3, i.e. an image 4 in the form of a print of alternating light and dark grey lines being arranged on the surface structure 5 as depicted in FIGS. 2a to 2c, are discussed.

That is, the print 4 being printed on the surface structure 5 corresponds to alternating light and dark grey lines, see FIG. 3a. FIGS. 3b to 3d show simulated appearances of the security element 3 comprising said print 4. That is, when the security element 3 is observed under the first viewing angle as depicted in FIG. 3b, the depressions 9 and elevations 8 of the surface structure 5 and consequently the light and dark grey lines are observable. Under the second viewing angle depicted in FIG. 3c, only the depressions 9 and consequently only the dark grey lines are observable to the observer. Under the third viewing angle depicted in FIG. 3d, only the elevations 8 and consequently only the light grey lines are observable to the observer. Because the observer is observing the security element 3 at a distance where the individual lines cannot be distinguished from one another, an overall dark grey image 4 and an overall light grey image 4 are observable by the observer when the security element is viewed under the second and third viewing angles, respectively.

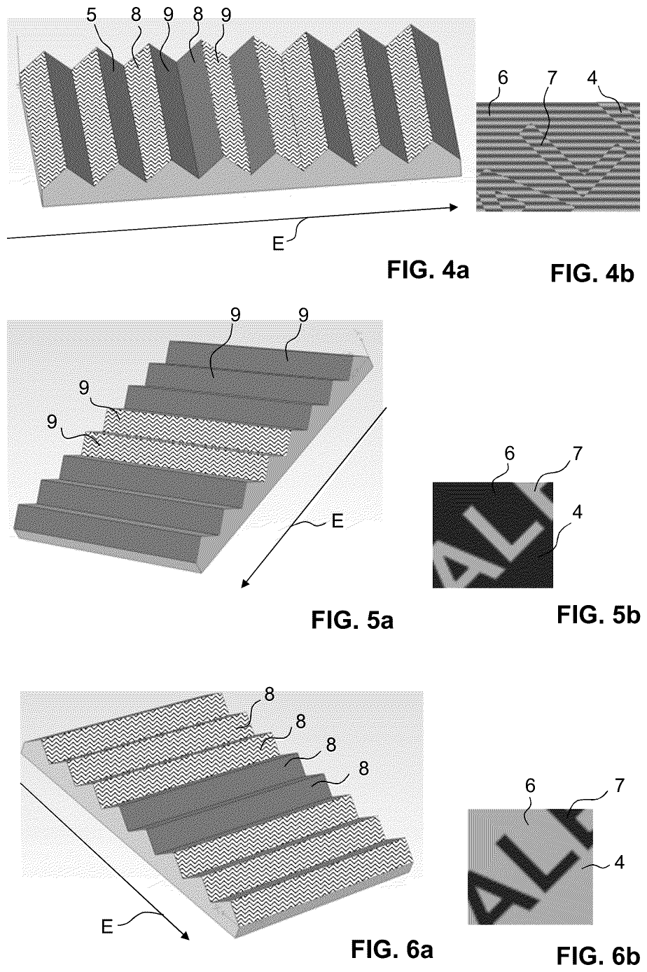

FIGS. 4a to 6b illustrate this effect for another image, i.e. another print 4. In fact, said print 4 does not comprise regularly alternating colours as it is the case in FIGS. 3a to 3d but some of the colour lines are shifted along the extension direction E. In the depicted example, the same colour, here dark grey, is arranged on a depression 9 being arranged adjacent or neighbouring to an elevation 8. Hence, depending on the viewing angle of the data carrier 1 either all dark grey lines and only two light grey lines are observable (FIG. 5a) or all light grey lines and only two dark grey lines are observable (FIG. 6a).

As becomes evident from FIGS. 4b, 5b and 6b, said shifting of colour lines is preferably present only in areas of the print 4. See for example FIG. 4b, wherein it can be recognized that there are regularly alternating lines being somehow interrupted by the still alternating, however shifted lines. The former lines constitute the primary area and thus the primary image 6, wherein the shifted lines constitute the secondary area and thus the secondary image 7. Here, the secondary image 7 has the shape of a text, wherein in the depicted partial views part of said text, namely “ALE”, is visible. Under the first viewing angle both sides of the ridges constituting the surface structure 5 and thus both colours of the secondary image 7 are visible, see FIG. 4b. Under the second viewing angle depicted in FIG. 5b, only colors that are printed on one side of the ridges are visible. Under the third viewing angle depicted in FIG. 6b only colors that are printed on the other side of the ridges of are visible. As a result, the secondary image 7 appears in different appearances depending on the viewing angle, namely in light grey as depicted in FIG. 5b whereas it appears in dark grey in FIG. 6b.

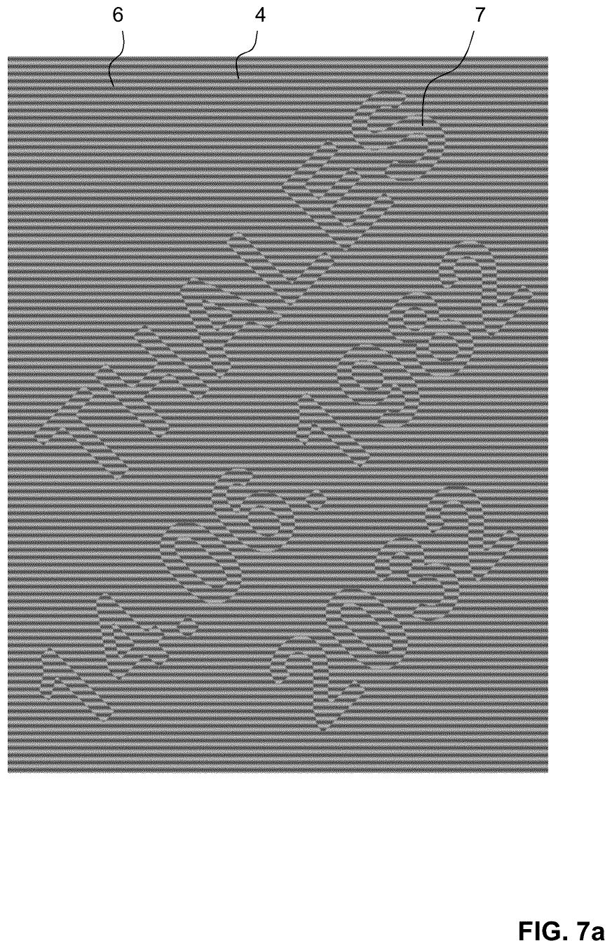

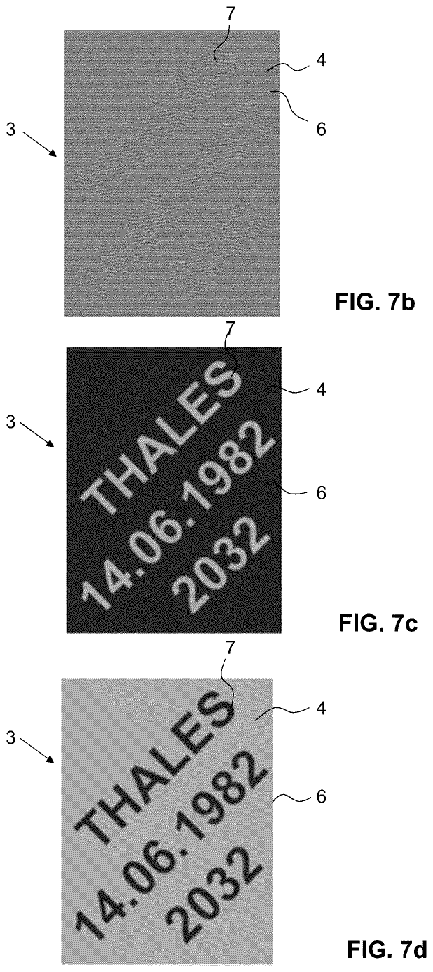

Since FIGS. 4a to 6b depict only partial views of the image 4 in the form of the print and the surface structure 5, the appearance of the entire print 4 is now discussed with reference to FIGS. 7a to 7d. In fact, the entire print 4 comprising the primary image 6 and the secondary image 7 is visible in FIG. 7a, from which follows that the entire print 4 corresponds to alternating light and dark grey lines, wherein parts of the lines are shifted along the extension direction E. In other words, an order of some of the alternating lines is changed locally at positions inside the image 4 that forms here an alphanumerical text and that constitute the secondary image 7. The area outside said secondary image 7 constitutes the primary image 6. Under a first viewing angle depicted in FIG. 7b the depressions 9 and elevations 8 or the left and right ridges, respectively, are observable. As such, both color A and color B or here the light grey and the dark grey are visible. Under the second viewing angle depicted in FIG. 7c color B or the dark grey is visible except at location where the order of the lines was changed: the alphanumerical text appears with color A or light grey. Under the third viewing angle the colors appear inverted compared to the second viewing angle: the alphanumerical text appears with color B or dark grey and the primary image, which forms here a background for the alphanumeric text, appears with color A or light grey.

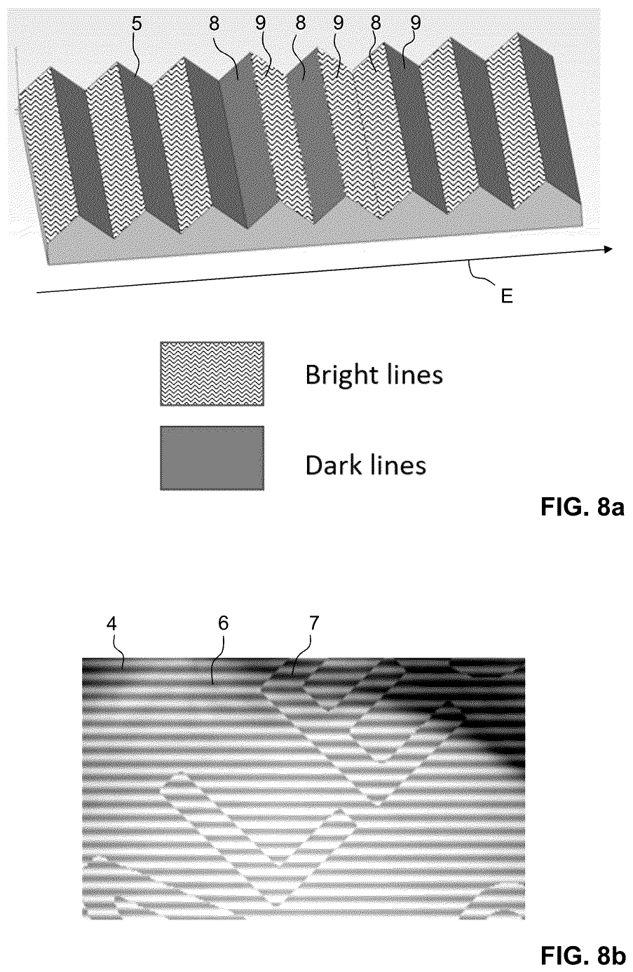

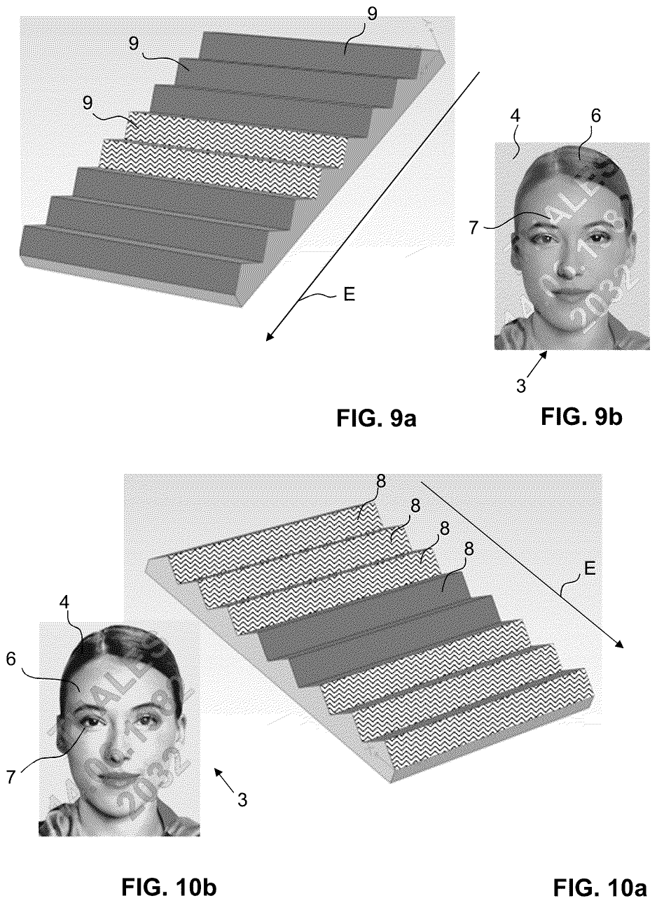

FIGS. 8a to 10a show different views of a surface structure 5 seen under different viewing angles, wherein the print 4 on the surface structure 5 comprises again alternating lines however of a different brightness. Some of the lines are again shifted or interchanged. Hence, under a first viewing angle depicted in FIGS. 8a and 8b both bright and dark lines are visible. Under a second viewing angle depicted in FIGS. 9a and 9b only lines that are printed on one side of the ridges are visible. Under a third viewing angle depicted in FIGS. 10a and 10b only lines that are printed on the other side of the ridges of the surface structure are visible. Consequently, the secondary image 7 appears differently, in particular with a brighter and less brighter appearance, compare FIGS. 9b and 10b.

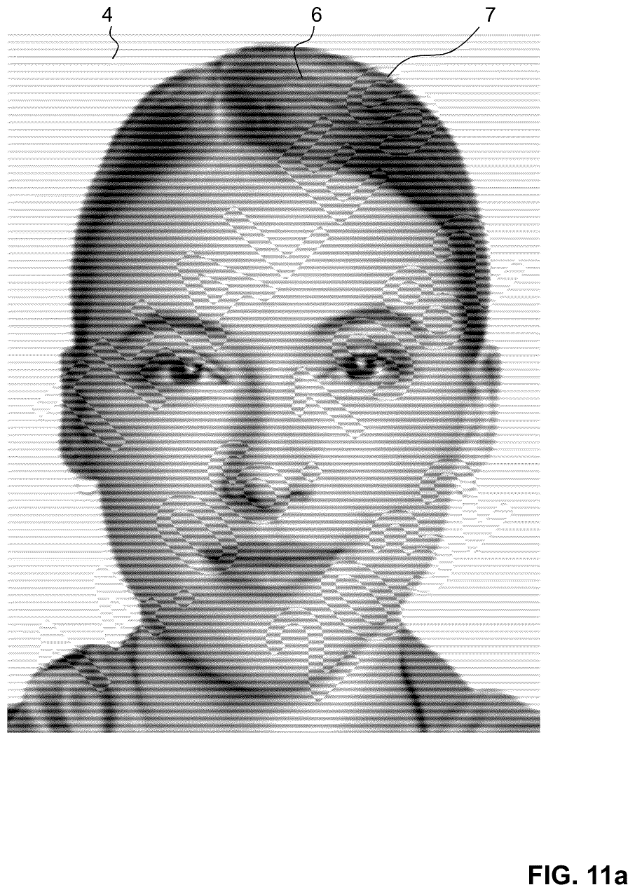

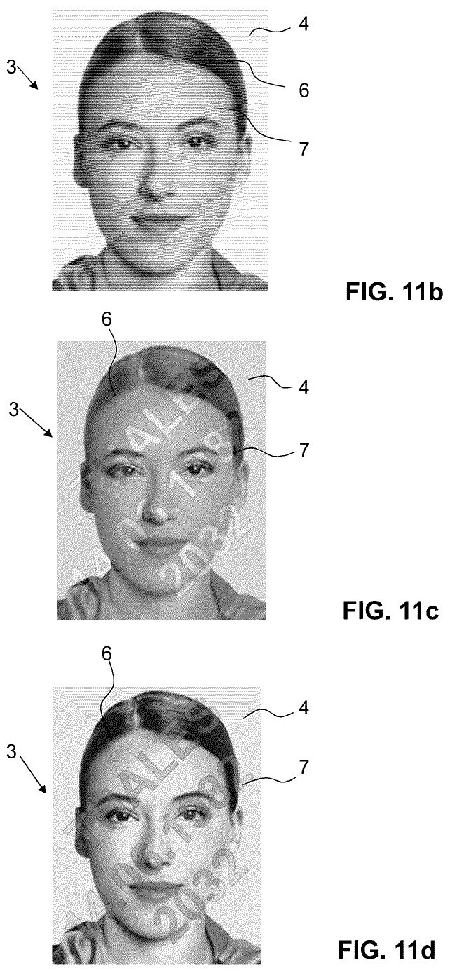

FIGS. 11a to 11d show simulated views of an entire image 4 in the form of a print being printed on a surface structure 5 as described in FIGS. 8a to 10a, wherein the print 4 corresponds to an original image in the form of a portrait that has been modulated according to a modulation pattern in the form of alternating light and dark grey lines and wherein part of this modulation has been shifted. In other words, FIG. 11a depicts an image 4 being composed of alternating light and dark grey lines being added to an original image in the form of a portrait image. The shifting corresponds again to the order of the alternating lines being changed locally at positions inside the portrait so as to form an alphanumerical text 7. Under the first viewing angle depicted in FIG. 11b the observer sees the elevations 8 and depressions 9 of the surface structure 5 and consequently an average of the alternating light and dark lines and therefore the portrait 4 without the alphanumerical text 7. In other words, the alphanumeric text being the secondary image 7 is encoded in the primary image 6. Under the second viewing angle depicted in FIG. 11c the portrait 6 is visible with a dark appearance except at locations where the order of the alternating lines was changed: the secondary image 7 in the form of the alphanumerical text appears with a bright appearance. Under the third viewing angle depicted in FIG. 11d the colors are inverted compared to the second viewing angle: the secondary image 7 in the form of the alphanumerical text appears with dark appearance while the remaining part of the image appears with bright appearance.

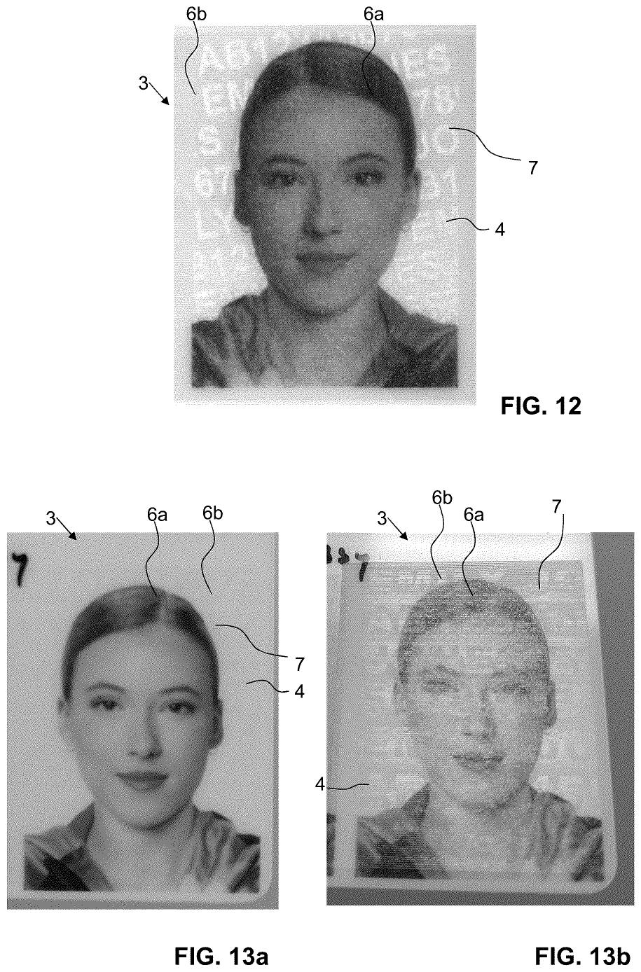

FIGS. 12 to 15 show simulated views of a security element 3 comprising an image 4 in the form of a print being printed on a surface structure as described previously. These examples however differ from the previous examples in that the secondary image 7 is a transparent, in particular a clear varnish print that is encoded and in particular printed on a primary image 6. In the depicted examples the primary image 6 comprises a first primary image part in the form of a coloured portrait 6a and a second primary image part in the form of a non-coloured and white image background 6b.

That is, the secondary image is a varnish printed with a pattern of droplets or the like being encoded as it has been described above for the secondary image in the form of visible inks. The encoding effect likewise depends on the surface structure and the viewing angles and/or illumination angles, however with the difference that the change in appearance is a variation in the reflectance, wherein said variation in reflectance preferably occurs from one colour pixel to another colour pixel. As in the previously described examples, the surface structure preferably hides colour pixels printed behind the surface structure when the data carrier is viewed under particular viewing angles/illumination angles.

In particular, FIG. 12 depicts a secondary image 7 in the form of a transparent varnish that is printed on the white background 6b of the portrait 6a. The effect is highly eye-catching and appears when the data carrier 1 is tilted and light reflects from the surface of the data carrier 1.

FIGS. 13a and 13b depict a security element 4 wherein the secondary image 7 in the form of the varnish is printed on the background 6b of the primary image as well as on top of the coloured portrait 6a of the primary image. Because of the transparency of the varnish 7, the coloured primary image 6a, i.e. the visible portrait is not disturbed. FIG. 13a depicts the security element 4 being observed under a 90 degree viewing angle and FIG. 13 b depicts the security element 4 being observed under a tilted viewing angle.

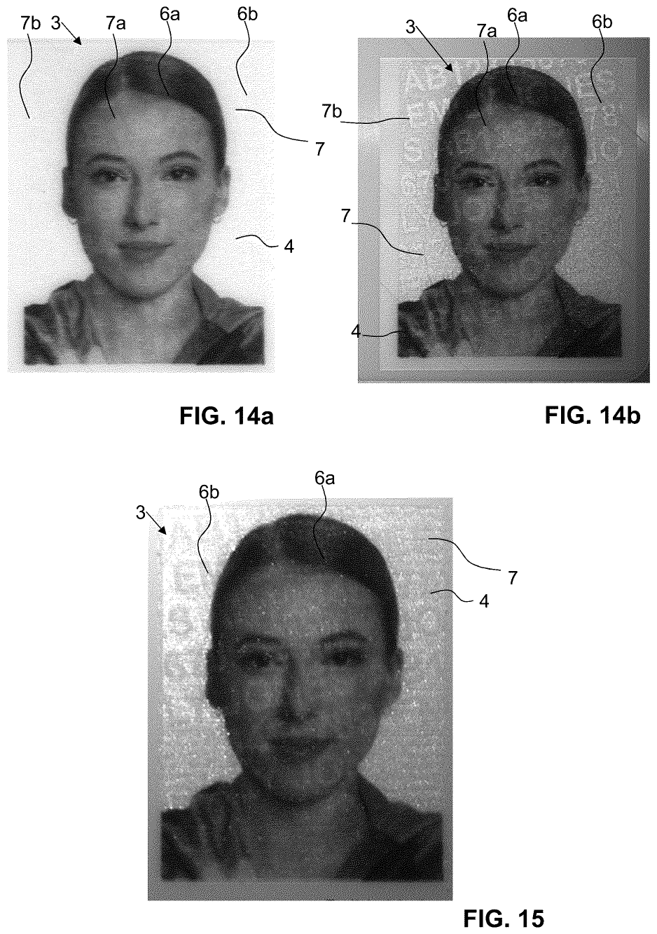

FIGS. 14a and 14b depict a combination, wherein the encoded secondary image 7 comprises both, a coloured secondary image part 7a and a transparent secondary image part 7b that are encoded in a coloured first primary image part 6a in the form of the portrait and in a second primary image part 6b in the form of a white background. FIG. 14a depicts the security element 4 being observed under a normal viewing angle and FIG. 14b depicts the security element 4 being observed under a tilted viewing angle.

FIG. 15 illustrates that the varnish printing offers yet another possibility: Instead of a lamination process, the decoding surface structure 5 can be printed with the varnish itself for instance on a mirror surface document of a data carrier. The process is simply to first print, for instance, horizontal lines with varnish with correct pitch and adequate height for the decoding, wherein the surface structure 5 is generated. After this, the encoded secondary image 7 such as alphanumeric text pictures are printed on top of the primary image 6 such as the portrait just like in the examples described above. That is, FIG. 15 illustrates an embodiment wherein the surface structure 5, the primary image 6 in the form a coloured portrait 6a with a white background 6b as well as the secondary image 7 in the form of a varnish background are all generated via inkjet printing.

At this point, it is noted that the just described varnish-printing technique can also be used paper products, either by intaglio embossing or with inkjet embossing. The just described provision of a transparent and/or varnish secondary element that can be provided by varnish printing techniques brings additional advantages:
Enables new visual look of the security element: Optically variable light reflection instead of, for instance, a color change;
Enables colorshift effects on non-coloured such as white areas of the primary image;
Enables colorshift effects on top of a non-encoded primary image;
Enables a combination of colorshift and varnish printing technique on the primary image;
Enables inkjet colorshift on mirror surface documents.

### LIST OF REFERENCE SIGNS

1 data carrier
2 carrier body
3 security element
4 image
5 surface structure
6 primary image
6a first primary image part
6b second primary image part
7 secondary image
7a first secondary image part
7b second secondary image part
8 elevation
9 depression
10 top side
11 original image
12 modulation pattern
13 top surface
E extension direction

What is claimed is:

1. A data carrier (1) for a secure article such as a passport comprising:
a carrier body (2), and
at least one security element (3) on the carrier body (2);
wherein the security element (3) comprises at least one image (4) printed on at least one surface structure (5) extending along an extension direction (E),
characterized in that the image (4) comprises at least one primary image (6) and at least one secondary image (7) encoded in the primary image (6), and
wherein the surface structure (5) is configured to decode the secondary image (7) when the data carrier (1) is viewed under different viewing angles and/or illuminated under different illumination angles, whereby the secondary image (7) becomes observable.

2. The data carrier (1) according to claim 1, wherein the primary image (6) is observable when the data carrier (1) is viewed under at least a first viewing angle and a second viewing angle and/or when the data carrier (1) is illuminated under at least a first illumination angle and a second illumination angle, and
wherein the secondary image (7) is hidden when the data carrier (1) is viewed under the first viewing angle and/or when the data carrier (1) is illuminated under the first illumination angle but observable when the data carrier (1) is viewed under the second viewing angle and/or when the data carrier (1) is illuminated under the second illumination angle.

3. The data carrier (1) according to claim 1, wherein the security element (3), in particular the primary image (6) and/or the secondary image (7), is configured to exhibit different appearances when the data carrier (1) is viewed under different viewing angles and/or illumination angles, and
wherein the different appearances are preferably at least one of a different luminescence, different colour, different intensity, different brightness, or different reflectance.

4. The data carrier (1) according to claim 1, wherein at least part of the primary image (6) and/or at least part of the secondary image are of a single-colour or a multi-colour, and/or
wherein at least part of the primary image is at least one of non-coloured, white, or grey and/or at least part of the secondary image is transparent and/or comprises or consists of a varnish.

5. The data carrier (1) according to claim 1, wherein at least part of the primary image (6) comprises primary colour pixels and the secondary image (7) comprises secondary colour pixels, wherein the primary image is modulated according to at least one modulation pattern (12) and the secondary image is modulated according to the at least one modulation pattern (12) but shifted preferably by a half-period of the modulation pattern (12), whereby a difference in appearance between the primary colour pixels and the secondary colour pixels is created when the data carrier (1) is viewed under different viewing angles while an average appearance of the security element (3) remains unchanged.

6. The data carrier (1) according to claim 1, wherein the primary image (6) and the secondary image (7) are observable to an un-aided eye, and/or
wherein the security element (3) is self-verifying.

7. The data carrier (1) according to claim 1, wherein the surface structure (5) comprises elevations (8) extending away from the carrier body (2) and/or depressions (9) extending towards the carrier body (2), and
wherein, at least in regions, a distance between and/or a surface area of and/or a slope of the elevations (8) and/or of the depressions (9) preferably remains constant or changes with respect to the extension direction (E).

8. The data carrier (1) according to claim 1,
wherein the surface structure (5) is associated with a surface pitch, and
wherein the surface pitch is configured for decoding the secondary image (7) encoded in the primary image (6).

9. The data carrier (1) according to claim 8, wherein, at least in regions, a primary pitch associated with the primary image (6) matches or mismatches the surface pitch, and/or
wherein, at least in regions, a secondary pitch associated with the secondary image (7) matches or mismatches the surface pitch.

10. The data carrier (1) according to claim 1, wherein the primary image (6) and/or the secondary image (7) are at least one of:
a picture and/or an alphanumeric character such as a name, date of birth, country of residence, coat of arms or the like, or
machine readable.

11. The data carrier (1) according to claim 1, wherein at least one of:
the data carrier (1) further comprises at least one marking material configured to interact with impinging laser radiation, and wherein the surface structure (5) corresponds to a laser marking generated in the marking material,
the surface structure (5) corresponds to an embossing,
the carrier body (2) and/or the surface structure (5) comprises or consists of one or more paper-based compounds and/or one or more cardboard-based compounds and/or one or more plastics and/or one or more polymers, or
the surface structure (5) corresponds to a print, preferably an inkjet print.

12. The data carrier (1) according to claim 1,
wherein the data carrier (1) defines a top side (10), and
wherein the security element (3) is provided on the top side (10) of the data carrier (1).

13. A secure article comprising or consisting of at least one data carrier (1) as claimed in any one of the preceding claims, the secure article preferably an identity card, a passport, a credit card, a smart card, a driving license, a data page or the like.

14. A method of producing a data carrier (1) for a secure article such as a passport, the data carrier (1) preferably the data carrier (1) as claimed in any one of claims 1 to 12, wherein the method comprises the steps of:
Providing a carrier body (2), and
Providing at least one security element (3) provided on the carrier body (2);
wherein the security element (3) comprises at least one image (4) printed on at least one surface structure (5) extending along an extension direction (E),
characterized in that the image (4) comprises at least one primary image (6) and at least one secondary image (7) encoded in the primary image (6), and
wherein the surface structure (5) is configured to decode the secondary image (7) when the data carrier (1) is viewed under different viewing angles and/or illuminated under different illumination angles, whereby the secondary image (7) becomes observable.

15. The method according to claim 14, wherein the security element (3) is provided by:
Providing an original image (11);
Selecting at least a first area of the original image (11) to be assigned to the primary image (6) and selecting at least a secondary area of the original image (11) to be assigned to the secondary image (7), wherein the secondary area is preferably arranged inside the primary area;
Modulating the primary area according to at least one modulation pattern (12), whereby the primary image (6) is formed;
Modulating the secondary area according to the at least one modulation pattern (12) and shifting said modulated secondary area, whereby the secondary image (7) is formed;
Recombining the primary image (6) and the secondary image (7), whereby the image (4) is formed; and
Printing said image (4) onto the surface structure (5) preferably with an inkjet printer.

16. The method according to claim 15, wherein the modulation pattern corresponds to a screen preferably a round screen, line screen or elliptical screen, and/or
wherein the primary area and the secondary area are modulated by changing at least one of a luminance, intensity, brightness or colour of the primary area and the secondary area, preferably by of colour pixels to be assigned to primary colour pixels of the primary image (6) and of colour pixels to be assigned to secondary colour pixels of the secondary image (7), and/or
wherein the modulated secondary area is shifted along at least one spatial direction and/or along the extension direction (E), and/or
wherein the modulated secondary area is shifted in accordance with a surface pitch of the surface structure (5), the modulated secondary area preferably being shifted by half of the surface pitch.
